(19) United States
(12) Patent Application Publication
(10) Pub. No.: US 2021/0087485 A1
(43) Pub. Date: Mar. 25, 2021

(54) BIODIESEL FROM KARAYA OIL

(71) Applicant: King Abdullah University of Science and Technology, Thuwal (SA)

(72) Inventors: Bayan Mustafa WASFI, Thuwal (SA); Aiman Ali GALANDER, Khartoum (SD); Robert Woodrow DIBBLE, Thuwal (SA)

(21) Appl. No.: 17/043,761

(22) PCT Filed: Apr. 2, 2019
(86) PCT No.: PCT/IB2019/052702

§ 371 Date: Sep. 30, 2020

Related U.S. Application Data
(60) Provisional application No. 62/652,557, filed on Apr. 4, 2018.
(60) Provisional application No. 62/670,171, filed on May 11, 2018.
(60) Provisional application No. 62/782,854, filed on Dec. 20, 2018.

(51) Int. Cl. C10L 1/02; B01J 23/04

(52) U.S. Cl. CPC C10L 1/026; B01J 23/04; B01J 2523/13; C10L 2200/0484; B01J 2523/12; C10L 2200/0476

(57) ABSTRACT

Embodiments of the present disclosure describe methods of producing fuel additive compositions from karaya oil comprising reacting a karaya oil extract with an alcohol in the presence of a catalyst to produce fatty acid esters in a crude product mixture; and separating the fatty acid esters from the crude product mixture to obtain the fuel additive composition. Embodiments of the present disclosure further describe fuel additive compositions comprising a mixture of fatty acid esters from karaya oil, and fuel compositions comprising a fuel additive composition and optionally diesel fuel.

### BACKGROUND

It is widely accepted that increased CO₂ in the atmosphere has resulted in climate change. Accordingly, there is an interest in reducing CO₂ production. One promising route of reducing CO₂ production is through the development of biodiesel as fuel additives or fuel alternatives to petroleum diesel. Biodiesel is a common name for monoalkyl esters of long chain fatty acids derived from renewable sources, such as farm crops, animal fat, and waste oil. It offers the advantages of being a cleaner-burning and biodegradable, with lower CO₂ emissions as compared to petroleum diesel. However, biodiesel typically release high amount of NOx when combusted. NOx gases react to form smog and acid rain as well as being central to the formation of fine particles (PM) and ground level ozone, both of which are associated with adverse health effects. Further, the production of biodiesel from farm crops, for instance, can reduce food supply for human consumption, leading to un-optimized substitutes to conventional fuel. Accordingly, it would be desirable to develop methods of producing biodiesel from non-edible sources to increase the availability of biodiesel without reducing food supply for human consumption.

### SUMMARY

In general, embodiments of the present disclosure describe fuel additive compositions, methods of producing fuel additive compositions, fuel compositions, and the like.

Embodiments of the present disclosure describe fuel additive compositions comprising a mixture of fatty acid esters derived from karaya oil and optionally free fatty acids, soaps, catalysts, excess alcohols, unreacted oils and fats, or combinations thereof. The mixture of fatty acid esters can include mono-alkyl esters of long chain fatty acids, very long chain fatty acids, or both. Examples of such mono-alkyl esters include, but are not limited to, fatty acid methyl esters, fatty acid ethyl esters, fatty acid propyl esters, and higher alkyl esters.

Embodiments of the present disclosure also describe methods of producing fuel additive compositions by transesterification of karaya oil. The methods can comprise reacting a karaya oil extract with an alcohol in a presence of a catalyst to produce fatty acid esters in a crude product mixture and separating the fatty acid esters from the crude product mixture to obtain the fuel additive composition.

Embodiments of the present disclosure further describe fuel compositions comprising a fuel additive composition and/or diesel fuel. The fuel compositions can be provided as blends or mixtures of the fuel additive composition and the diesel fuel. The fuel compositions can comprise between about 0% to about 100% of the fuel additive composition and/or about 0% to about 100% of the diesel fuel.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of preparing a fuel additive composition, according to one or more embodiments of the present disclosure.

FIG. 2 is FTIR spectrum of karaya oil, according to one or more embodiments of the present disclosure.

FIG. 3 is a schematic diagram showing a sketch of the experimental setup, according to one or more embodiments of the present disclosure.

FIG. 4 is an image showing separation of acid and biodiesel using a manual/hand biodiesel purification procedure, according to one or more embodiments of the present disclosure.

FIG. 5 is an image of a centrifuge for biodiesel purification, according to one or more embodiments of the present disclosure.

FIG. 6 is a graphical view showing vapor pressure as a function of temperature, according to one or more embodiments of the present disclosure.

FIG. 7 are chromatograms for FAME yield at different conversions stages of karaya oil, according to one or more embodiments of the present disclosure.

FIG. 8 shows FTIR spectrum of karaya methyl ester, according to one or more embodiments of the present disclosure.

FIG. 9 is a graphical view showing karaya oil vs corn oil conversion in glass reactor, according to one or more embodiments of the present disclosure.

FIGS. 10A-10B are graphical views showing (A) ignition delay time and (B) pressure within the combustion chamber—Exp 1, according to one or more embodiments of the present disclosure.

FIGS. 11A-11B are graphical views showing (A) ignition delay time and (B) pressure within the combustion chamber—Exp 2, according to one or more embodiments of the present disclosure.

FIGS. 12A-12B are graphical views showing (A) ignition delay time and (B) pressure within the combustion chamber—Exp 3, according to one or more embodiments of the present disclosure.

FIGS. 13A-13B are graphical views showing (A) ignition delay time and (B) pressure within the combustion chamber—Exp 4, according to one or more embodiments of the present disclosure.

FIGS. 14A-14B are graphical views showing (A) ignition delay time and (B) pressure within the combustion chamber—Exp 5, according to one or more embodiments of the present disclosure.

FIGS. 15A-15B are graphical views showing (A) ignition delay time and (B) pressure within the combustion chamber—Exp 6, according to one or more embodiments of the present disclosure.

FIGS. 16A-16B are graphical views showing (A) ignition delay time and (B) pressure within the combustion chamber-karaya oil, according to one or more embodiments of the present disclosure.

FIG. 17 is a graphical view showing the difference in IQT between karaya and corn oil biodiesel, according to one or more embodiments of the present disclosure.

### DETAILED DESCRIPTION

Karaya oil is extracted from the seeds of a non-edible fruit grown on trees of the species Sterculia foetida. Being extracted from a non-edible, renewable source, the use of karaya oil for the production of biodiesel avoids the difficult tradeoff of food production versus biodiesel production faced by participants of the current biodiesel industry. The trees thus offer potential to provide enormous volumes of karaya oil for the production of biodiesel and/or fuel additives that can be blended with diesel fuel. The trees begin flowering early in their lifecycle and can produce fruits suitable for extracting karaya oil within 11 months from flowering, or within one or two years of planting. The karaya oil extracts contain a higher concentration of saturated fatty chains than other vegetable oils. While not wishing to be bound to a theory, it is believed that the high concentration of saturated fatty acids contributes to the performance of the fuel additives described herein as reflected by high cetane numbers and short ignition delay times, among other biofuels or substitutes.

The present disclosure novel processes for the production of fuel additive compositions derived from karaya oil. The fuel additive compositions described herein can be produced by a transesterification process in which triglycerides from a karaya oil extract react with an alcohol in the presence of a catalyst to produce fatty acid esters, such as mono-alkyl esters of long chain fatty acids, very long chain fatty acids, or a combination thereof, or preferably fatty acid methyl esters. For example, in a step-wise manner, the triglyceride can be converted to a diglyceride, a monoglyceride, and finally a fatty acid methyl ester and glycerol. The transesterification process can be base-catalyzed, or acid-catalyzed, and can optionally be combined with acidic esterification for the pretreatment of the karaya oil extract to remove water and free fatty acids. The methods described herein can be used to obtain high quality fuel additive compositions in high yield. For example, the fuel additive compositions can achieve a cetane number of 98 and ignition delay times of 2.4 ms.

The fuel additive compositions produced according to the methods of the present disclosure can comprise a mixture of fatty acid esters, such as mono-alkyl esters of long chain or very long chain fatty acids. Typically, the fuel additive compositions comprise low concentrations of byproducts and contaminants, such as glycerol, free fatty acids, soaps, catalysts, excess alcohols, unreacted oils and fats, diglycerides, monoglycerides, or combinations thereof. In addition, the fuel additive compositions can comprise mixtures in which all or a substantial portion thereof comprises fatty acid esters such as fatty acid methyl esters. The high quality of the fuel additive compositions allows them to be readily combined or blended with lower quality diesel fuel to form better quality fuel. Given that the fuel additive compositions are derived from non-edible karaya seeds, the fuel additive compositions offer the potential to produce enormous volumes of biodiesel to reduce CO₂ emissions, among other substitutes.

### Definitions

The terms recited below have been defined as described below. All other terms and phrases in this disclosure shall be construed according to their ordinary meaning as understood by one of skill in the art.

As used herein, “fuel additive” or “fuel additive composition” refers to biodiesel produced according to the methods of the present disclosure, which can be used alone, or it can be combined or blended with diesel fuel.

As used herein, “karaya oil” refers to an extract obtained from the seeds of fruit grown on trees that belong to the genus of Sterculia. For example, the karaya oil can be extracted from the seeds of fruit grown on trees of the species Sterculia foetida.

As used herein, “fatty acid” refers to a carboxylic acid with an aliphatic chain, which can be saturated or unsaturated. Where the aliphatic chain is unsaturated, the term “fatty acid” includes cis and trans isomers thereof. The aliphatic chain or tail of the fatty acid can have one or more carbons.

As used herein, “fatty acid ester” generally refers to an ester formed by the combination of a fatty acid and an alcohol. Fatty acid esters can generally be represented by the chemical formula: RC(O)OR′, wherein R is a carbon chain of a fatty acid and R′ is an alkyl group of an alcohol. The term “fatty acid ester” includes mono-alkyl esters of fatty acids, including, but not limited to, fatty acid methyl esters, fatty acid ethyl esters, fatty acid propyl esters, and so on.

As used herein, “reacting” generally refers to a transesterification process in which a fatty acid ester is produced by a reaction between a triglyceride and an alcohol, optionally in the presence of a catalyst, under suitable reaction conditions. For example, the reacting can proceed by contacting, heating, or combinations thereof.

As used herein, “contacting” refers to the act of touching, making contact, or of bringing to close or immediate proximity, including at the cellular or molecular level, for example, to bring about a physiological reaction, a chemical reaction, or a physical change (e.g., in solution, in a reaction mixture, in vitro, or in vivo). Contacting may refer to bringing two or more components in proximity, such as physically, chemically, electrically, or some combination thereof. Mixing is an example of contacting.

As used herein, “heating” refers to increasing a temperature. For example, heating may refer to exposing or subjecting any object, material, etc. to a temperature that is greater than a current or previous temperature. Heating may also refer to increasing a temperature of any object, material, etc. to a temperature that is greater than a current or previous temperature of the object, material, etc.

As used herein, “separating” generally refers to the act of removing one or more chemical species from one or more other species present in a bulk fluid composition (e.g., gas/vapor, liquid, and/or solid). For example, the separating can proceed by washing, centrifuging, or combinations thereof.

As used herein, “washing” refers to contacting with a solvent, such as a liquid solvent. The solvent may include one or more of an inorganic solvent, organic solvent, and aqueous solvent.

As used herein, “centrifuging” refers to rotation of a material or object about a rotational axis sufficient to separate components of the material or object. The material or object may be rotated by applying a force perpendicular or about perpendicular to the axis of spin.

Embodiments of the present disclosure describe fuel additive compositions comprising a mixture of fatty acid esters derived from karaya oil, and optionally other species, such as free fatty acids, soaps, catalysts, excess alcohols, unreacted oils and fats, or combinations thereof. Depending on the processes used to produce the compositions, the fuel additive compositions can include varying concentrations of the fatty acid esters and the other species. Typically, it will be desirable for all or a substantial portion of the fuel additive composition to comprise the mixture of fatty acids esters, with low concentrations, or even trace or undetectable amounts, of the other species. For example, a proportion of the mixture of the fatty acid esters in the fuel additive composition can be about 90% or greater, such as about 98% or greater. Accordingly, embodiments of the present disclosure also describe fuel additive compositions consisting of or consisting essentially of a mixture of fatty acid esters derived from karaya oil.

The mixture of fatty acid esters of the fuel additive compositions can be produced by transesterification of triglycerides from karaya oil with an alcohol in the presence of a catalyst under suitable reaction conditions. The mixture of fatty acid esters can include mono-alkyl esters of long chain fatty acids, very long chain fatty acids, or a combination of both. Examples of such mono-alkyl esters include, but are not limited to, fatty acid methyl esters, fatty acid ethyl esters, fatty acid propyl esters, and higher alkyl esters. As used herein, the term “long chain fatty acids” refers to fatty acids with aliphatic tails of 13 to 21 carbons. The term “very long chain fatty acids” refers to fatty acids with aliphatic tails of 22 or more carbons. Unless otherwise provided, the term “long chain fatty acids” shall generally be understood to include both long chain fatty acids (C13-C21 fatty acids) and very long chain fatty acids (C22+ fatty acids). The mixture of fatty acid esters can thus include a mixture of mono-alkyl esters of long chain fatty acids.

All or a substantial portion of the mixture of fatty acid esters derived from karaya oil can include fatty acid methyl esters (FAME). Accordingly, in an embodiment the fuel additive compositions comprise a mixture of mono-alkyl esters of long chain fatty acids, wherein the mono-alkyl esters of long chain fatty acids comprise, consist of, or consist essentially of, fatty acid methyl esters derived from karaya oil. Each of the fatty acid methyl esters of the mixture can be generally represented by chemical formula (I):

RC(O)OCH₃ (I)

wherein R is any saturated or unsaturated long aliphatic tail of a fatty acid. In the case of unsaturated fatty acid chains, the fatty acid methyl ester can include the cis and trans isomers thereof. The fuel additive composition will typically include more than one type of fatty acid methyl ester. Accordingly, the R of formula (I) shall be understood to vary and will be different for each type of fatty acid methyl ester included in the fuel additive composition.

Examples of fatty acid methyl esters that can be included in the fuel additive compositions include, but are not limited to, one or more of the following fatty acid methyl esters: methyl hexanoate; methyl octanoate; methyl nonanoate; methyl decanoate; methyl undecanoate; methyl laurate; methyl tridecanoate; methyl myristate; methyl myristoleate; methyl pentadecanoate; methyl 10-pentadecenoate; methyl palmitate; methyl palmitoleate; methyl heptadecanoate; methyl 10-heptadecenoate; methyl stearate; trans-methyl elaidate; cis-methyl oleate; methyl linoleate; methyl gamma linolenate; methyl arachidate; methyl 11-eicosanoate; methyl 11,14-eicosadienoate; methyl methyl homogamma linolenate; methyl arachidonate; methyl 11,14,17-eicosatrienoate; methyl behenate; cis-methyl 5,8,11,14,17-eicosapentenoate; methyl erucate; methyl 13,16-docosaidienoate; methyl lignocerate; cis-methyl 4,7,10,13,16,19-docosahexenoate; methyl nervonate; and isomers thereof.

As described above, the fuel additive compositions can optionally further comprise other species, such as free fatty acids, glycerol, soaps, catalysts, excess alcohols, unreacted oils and fats, or combinations thereof. These other species can be present as reaction byproducts or they can be present in the original reagents. Typically, the fuel additive composition includes a low concentration—or even trace, negligible, or undetectable amounts—of these optional species to meet, for example, industry standards (e.g., ASTM) for fuels and additives thereof and to maximize the performance characteristics and quality of the fuel additive. For example, the presence of free fatty acids can be undesirable because they are mildly acidic and thus their presence can lead to or cause corrosion in engines, production facilities, and the like.

In an embodiment, the fuel additive compositions can comprise, consist essentially of, or consist of one or more of palmitic acid methyl ester, palmitoleatic acid methyl ester, 10-heptadecanoic acid methyl ester, stearic acid methyl ester, oleic acid methyl ester, linoleic methyl ester, malvalic acid methyl ester, melissatic acid methyl ester, behenic acid methyl ester, and isomers thereof.

In an embodiment, the fuel additive composition achieves a cetane number of 95 or greater. In an embodiment, the fuel additive composition achieves a cetane number of 98. In an embodiment, the fuel additive composition achieves an ignition delay time of about 3 ms or less. In an embodiment, the fuel additive composition achieves an ignition delay time of about 2.4 ms.

Embodiments of the present disclosure further describe methods of producing fuel additive compositions derived from karaya oil. The fuel additive compositions can be prepared by a transesterification (or alcoholysis) process in which triglycerides from karaya-oil fats are reacted with an alcohol in the presence of a catalyst to produce fatty acid esters and glycerol. The transesterification process typically includes three reversible reactions in which the triglyceride is converted to a diglyceride, the diglyceride is converted to a monoglyceride, and the monoglyceride is converted to glycerol. A fatty acid ester can be liberated at each step of the conversion. A catalyst can be present to increase reaction rates and the yield of esters. An example of the overall reaction scheme of the transesterification process is represented below as (II):

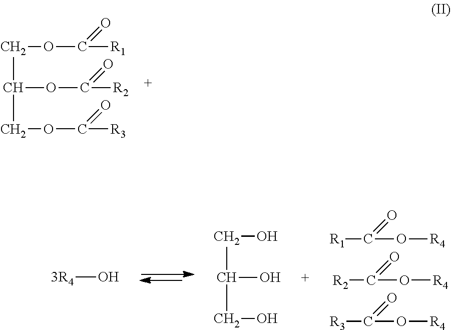

The products thus can include a mixture of fatty acid esters, such as mono-alkyl esters (e.g., fatty acid methyl esters) and glycerol.

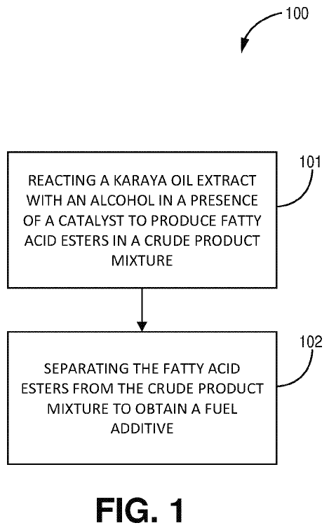

FIG. 1 is a flowchart of a method of producing fuel additive compositions by transesterification of karaya oil, according to one or more embodiments of the present disclosure. As shown in FIG. 1, the method can comprise one or more of the following steps: reacting 101 a karaya oil extract with an alcohol in a presence of a catalyst to produce fatty acid esters in a crude product mixture; and separating 102 the fatty acid esters from the crude product mixture to obtain the fuel additive composition.

The step 101 includes reacting a karaya oil extract with an alcohol in a presence of a catalyst under suitable conditions to produce fatty acid esters in a crude product mixture. The reacting can generally proceed by any suitable means. For example, the reacting can proceed by contacting the karaya oil extract with the alcohol and catalyst to form a reaction solution. As used herein, the term “contacting” refers to bringing two or more components into physical contact, or immediate or close proximity. The reacting can optionally further proceed by heating the reaction solution to or at a first temperature. As used herein, the term “heating” refers to increasing a temperature. The heating can be applied to the reaction solution to increase the reaction rate. The first temperature can be a temperature of about 60° C. or more. In an embodiment, the first temperature can range from about 60° C. to about 140° C., such as about 60° C., about 100° C., about 120° C., or about 140° C. The reacting can optionally further proceed at pressures ranging from ambient pressure to about 5 bar. In an embodiment, the reacting can proceed under supercritical karaya oil conditions and/or subcritical or supercritical alcohol conditions. For example, in an embodiment, supercritical karaya oil conditions can be used to allow the fluid to diffuse massively and thus allow reactant particles to interact intensively. Karaya extract under supercritical conditions estimated to be optimum under pressure of about 300 bar and temperature of about 50° C. Under these conditions, karaya extracts may have higher levels of linoleic and linolenic acids and lower levels of palmitic and stearic acids compared to karaya extract by organic solvent. The methanol can then act as superheated steam under high pressure and the higher the steam pressure the lower the volume, which can improve equipment lifetimes.

In an embodiment, the karaya oil can be pretreated to reduce the percentage of free fatty acids that are present in the oil as well as remove all or some water. This can be performed to avoid issues with contamination and saponification. For example, in an embodiment, the karaya oil can be subjected to acidic esterification when mixing methanol with sulfuric acid and oil. The free fatty acids can be used to produce methyl esters. The result can be an increase in the yield and complete or nearly complete prevention of soap formation.

In an embodiment, the alcohol and catalyst can be combined to form a mixture prior to the reacting, the mixture can be heated, and then reacted with the karaya oil extract to produce the fatty acid esters. For example, the alcohol and the catalyst can be combined to form a mixture by dissolving the catalyst in the alcohol, mixing the catalyst with the alcohol, or contacting the catalyst and the alcohol. In an embodiment, the karaya oil extract, and the mixture or the components thereof (e.g., alcohol and catalyst) can be heated separately to a second temperature, prior to the reacting (e.g., prior to contacting). The second temperature can be any temperature suitable for minimizing flash evaporation loss of the alcohol. For example, where the alcohol is methanol, the second temperature can be as high as about 40° C.

The alcohol is typically provided in excess of the karaya oil extract. For example, the transesterification process can be a reversible reaction. Accordingly, the alcohol can be provided in excess of the karaya oil extract to shift the chemical reaction favorably towards the formation of fatty acid esters. The alcohol can also be provided in excess of the karaya oil extract to increase the reaction rate of the transesterification of the triglycerides from the karaya oil extract with the alcohol. A suitable ratio of alcohol to karaya oil extract (e.g., triglycerides) can be a molar ratio of about 3:1, but any molar ratio is sufficient as long as the alcohol is provided in excess of the karaya oil extract. Typically, the reaction performance is enhanced as the molar ratio of the alcohol to triglycerides increases. Accordingly, in an embodiment, the ratio of alcohol to karaya oil extract or triglycerides can be a molar ratio of about 6:1, about 12:1, or even higher. The ratio is not particularly limited, so long as the alcohol is provided in excess of the karaya oil extract.

The karaya oil is generally extracted from the seeds of karaya fruit and thus the composition of the karaya oil extract can vary depending on the technique employed for the extraction, geographic location from which the karaya fruit seeds were obtained, and other such factors and variables. For example, various extraction techniques can be employed, including, but not limited to, solvent-solvent extraction, cold solvent extraction, and mechanical pressing. Each technique can result in different quantities of karaya oil. In a typical case, the karaya oil extract will generally contain at least a suitable concentration of triglycerides, and possibly other glycerides, such as monoglycerides and diglycerides. It also would not be uncommon for the karaya oil extract to contain some concentration of free fatty acids and/or water. It may be desirable to remove the free fatty acids and/or water because, in the case of a basic catalyst, the presence of free fatty acids and/or water can lead to saponification, as well as require harsher reaction conditions and decrease yield, among other things. Thus, although not required, the free fatty acids and/or water can be removed or the karaya oil extract can be treated to reduce their presence to low or trace amounts. For example, in an embodiment, the karaya oil extract can be pretreated using an acidic esterification process in which the free fatty acids can be esterified to form, for example, fatty acid methyl esters and remove/reduce the presence of water.

The alcohol can generally include any alcohol, such as primary, secondary, or tertiary monohydric aliphatic alcohols. For example, the alcohol can be a lower alcohol, such as methanol, ethanol, and propanol, or it can be a higher alcohol, such as isopropanol and butanol. Examples of suitable alcohols can thus include, but are not limited to, methanol, ethanol, propanol, butanol, amyl alcohol, isopropanol, and butanol. The alcohol can be selected to produce a desired fatty acid ester. For example, methanol can be selected to produce fatty acid methyl esters, whereas ethanol can be selected to produce fatty acid ethyl esters. Typically, methanol is used as the alcohol because of its low cost and ability to readily dissolve catalysts, such as sodium hydroxide, among others.

The catalyst can be a homogenous or heterogenous catalyst. The catalyst can generally be selected from the group consisting of basic catalysts and acidic catalysts. The basic catalysts can be alkali metal catalysts. For example, the alkali metal catalysts can be selected from the group consisting of alkali hydroxides, alkali carbonates, and alkali alkoxides. Examples of suitable alkali metal catalysts can include, but are not limited to, sodium hydroxide, potassium hydroxide, sodium carbonate, potassium carbonate, sodium methoxide, sodium ethoxide, sodium propoxide, and sodium butoxide. The acidic catalysts can be selected from the group of Lewis acids, Arrhenius acids, and Bronsted-Lowry acids. Examples of suitable acidic catalysts can include, but are not limited to, sulfuric acid, hydrochloric acid, and sulfonic acids.

The reaction can thus proceed as a base-catalyzed transesterification process, acid-catalyzed transesterification process, or a combination of both. The base-catalyzed process can be preferred because it typically proceeds at a faster reaction rate than acid-catalyzed processes and at comparatively lower temperatures and pressures and also because basic catalysts are usually lower in cost. However, basic catalysts can be sensitive to water and free fatty acids. For example, the presence of water and/or free fatty acids in the karaya oil extract can cause hydrolysis of water and/or saponification, resulting in fatty acid salts (e.g., soaps). Accordingly, in cases where water and/or free fatty acids are present in the karaya oil or otherwise in the reaction solution, it may be desirable to proceed with acid-catalyzed transesterification using an acidic catalyst, which can be more stable than basic catalysts under such conditions and can esterify the free fatty acids to produce fatty acid esters, or it can be desirable to proceed at least initially with acidic esterification and then with the base-catalyzed transesterification process.

The step 102 includes separating fatty acid esters from the crude product mixture to obtain a fuel additive. The reaction results in the formation of a crude product mixture. The major constituents of the crude product mixture are typically the fatty acid esters and a glycerol byproduct. The crude product mixture can further include contaminants and byproducts, such as one or more of glycerol, free fatty acids, soaps, catalysts, excess alcohols, unreacted oils and fats, diglycerides, and monoglycerides. Such contaminants are typically present lower amounts relative to the major constituents described above. The fatty acid esters can thus be obtained (e.g., isolated, purified, etc.) by separating them from the glycerol byproduct and contaminants.

The separating can be achieved by any suitable means. For example, the separating can be achieved by washing the crude product mixture with one or more solvents to phase separate the various components such that they can be removed, either sequentially or simultaneously, from the crude product mixture. In an embodiment, the separating can proceed by washing the crude product mixture one or more times with a suitable amount of water and vinegar. As the washing proceeds, a phase separation can be observed between the fatty acid ester layer and the layer containing glycerol and optionally one or more of the contaminants described above. The glycerol is typically the heavy phase (but it need not to be) and thus it generally occupies the lower portion of the vessel used for the separation, with the fatty acid esters layer above it. A period of time can be allowed for settling and then the glycerol and/or contaminant phase can be removed to obtain the fatty acid esters as the fuel additive.

The separating can also be achieved by centrifuging the crude product mixture to separate the fatty acid esters from glycerol and/or contaminants. A disk-stacked centrifuge is typically used, but any suitable centrifuge can be used to achieve the separation. The centrifuging can be a more efficient technique for achieving the separation as it usually provides shorter residence times for batch and continuous operations. After centrifuging, the fatty acid esters can be recovered as the fuel additive.

Embodiments of the present disclosure describe a fuel composition comprising a fuel additive compositions and/or diesel fuel. The fuel compositions can be provided as blends or mixtures thereof. The fuel additive compositions can include any of the fuel additive compositions of the present disclosure, such as any of the fuel additive compositions described herein or prepared according to the methods described herein. The diesel fuel can include any petroleum-based diesel known in the art. The fuel composition can comprise between about 0% to about 100% of the fuel additive composition and/or about 0% to about 100% of the diesel fuel. For example, the fuel composition can include about 100% of the fuel additive composition, about 20% of the fuel additive composition and about 80% of the diesel fuel, about 5% of the fuel additive composition and about 95% of the diesel fuel, and/or about 2% of the fuel additive composition and about 98% of the diesel fuel.

The following Example is intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

The present Example describes the transesterification of Karaya oil using a batch reactor at about 100-140° C. and about 5 bar in subcritical methanol conditions, with a residence time from about 10 to 20 minutes, using a mass ratio of 6:1 of methanol-to-karaya oil. Methanol was used for alcoholysis and sodium hydroxide was used as a catalyst. Experiments varied the temperature and pressure, observing the effect on the yield and reaction time. In addition, biodiesel from corn oil was created and compared to biodiesel from karaya oil.

A kinetic model proposed is also described in this Example. The model estimated the concentration of triglycerides, diglycerides, monoglycerides and methyl esters during the reaction. The experiments were carried out at temperatures of about 100° C. and above. The conversion rate and composition of methyl esters produced from vegetable oils were determined by Gas Chromatography Analysis. It was found that the higher the temperature, the higher reaction rate. Highest yield was about 97% at a temperature of about 140° C. achieved in about 13 minutes, whereas at a temperature of about 100° C., the yield was about 68% in the same time interval.

Ignition Quality Test (IQT) was used for determining the ignition delay time (IDT) inside a combustion chamber. From the IDT, the cetane number CN was determined. In the case of corn oil biodiesel, the IDT was 3.5 mS, leading to a CN of 58. Whereas karaya oil biodiesel showed IDT of 2.4 mS, leading to a CN of 97-98.

The produced methyl esters were also characterized by measurements of viscosity (ν), density (ρ), flash point (FP) and heat of combustion (HC). The following properties observed:

For corn biodiesel, ν=8.8 mPa-s, ρ=0.863 g/cm3, FP=168.8° C., and HC=38 MJ/kg.
For karaya biodiesel, ν=10 mPa-s, ρ=0.877 g/cm3, FP=158.2° C., and HC=39 MJ/kg.

### Materials and Methods

### Materials

In this investigation, karaya oil was extracted from karaya fruit seeds and used to perform a transesterification process of the triglycerides in a batch reactor. Methanol was used in the transesterification process for the production of alkyl ester. A homogenous catalyst of sodium hydroxide was utilized for the reason of having more efficient products in accordance to time rate of the reaction. Before karaya oil was applied, corn oil was initially used to test the system ability to produce biodiesel (BD).

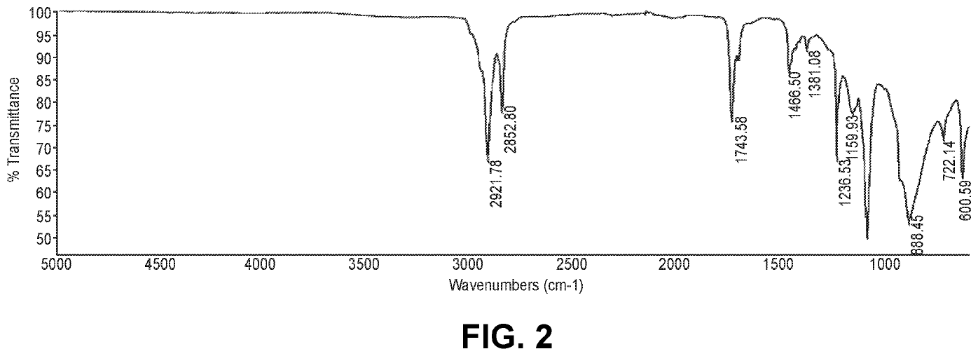

Karaya seeds were purchased from farmers in Sudan. The karaya seeds contained (or generally contain) about 25.65% fiber, about 3.45% ash, about 11.12% carbohydrates, about 24.10% protein, and about 25.25% crude oil. The oil was mechanically extracted. The following physical properties were approximated based on literature: 0.85 kg/l density, 0.09% free fatty acid content, 0.09% water content. Sodium hydroxide powder was purchased (DAC Drain Opener) as a homogenous catalyst with about 75% of NaOH and about 15-30% NaCl. And certified methyl alcohol had a purity of about 98%, so no further purification was needed. The molecular weight of karaya oil was assumed to be about 875 in all the calculations. Table 1 shows the physico-chemical properties of karaya crude oil. Table 2 shows the fatty acids composition of karaya crude oil. FIG. 2 is FTIR spectrum of karaya oil, according to one or more embodiments of the present disclosure.

Other extraction methods can be used. In general, the extraction methods can include mechanical extraction, such as mechanical pressing, solvent-solvent extraction, and cold solvent extraction. Each can produce different oil yields. For example, the oil yield (wt %) for solvent-solvent extraction can be about 32.4%. The oil yield (wt %) for cold solvent extraction can be about 26.0%. The oil yield (wt %) for mechanical pressing can be about 18.2%.

### Reactor

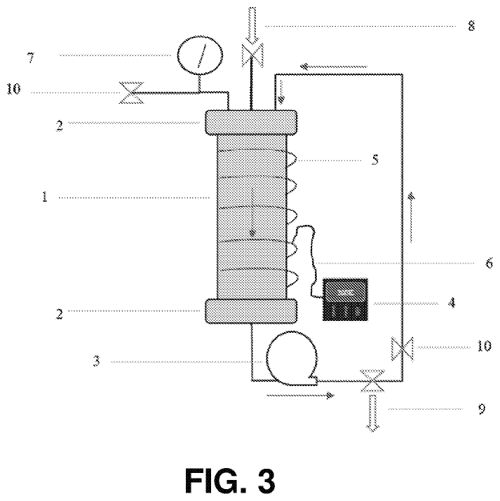

The reactor used is shown schematically in FIG. 3. In operation, the oil was weighed into inlet port 8. Methoxide was added to the oil using the same inlet port to the reacting chamber 1. The heaters were turned on using temperature controllers 4 that were equipped with heating tape 5 and thermocouples 6. The pump 3 was used to stir the mixture of oil:methanol:catalyst. Lastly, sampling ports 9 were placed to simplify the biodiesel collection process. More detail regarding the reactor is provided in Table 3.

The reactor was equipped with a pump used for mechanical stirring. The reactor was also equipped with input, output and sample ports. In order to avoid the escape of methanol vapor, Teflon tape was rounded over any helical threads before fastening to prevent the leakage of gases and fluid. The formed products were collected using the sample ports shown in FIG. 3 and cooled in an ice bath to stop the reaction from continuing. The reason for cooling the samples as soon as it exited the reactor was to minimize the relative large heat transfer area between the pipe and air and due to the low flowrate of each feedstock.

### Methods

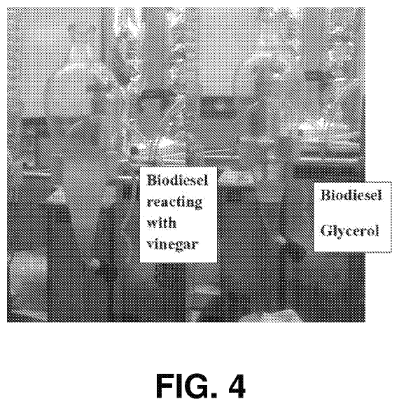

Experimental Procedure. The procedures used to produce BD from karaya oil and corn oil for comparison purposes are provided. (1) A volume of about 400-800 ml of karaya oil was prepared and placed inside a reactor. Heating tapes were switched on to the desired heating temperature, which was about 60-140° C. A pump was switched on to mechanically stir the oil during heating to a power of −1000 rpm. (2) The desired volume of methanol (about 150-300 ml) was prepared. A desired mass of sodium hydroxide (about 3.5-7 g) was measured and then added to it. Both elements were mixed vigorously using a manual stirring method, until the sodium hydroxide particles were completely dissolved, forming a methoxide solution. (3) The methoxide solution was added and the reactor temperature was increased until it reached the desired temperature. (4) Sample withdrawals occurred after a few minutes of the reactions. The intervals of sample collections were equally distributed time (e.g., a sample was collected every 2 minutes for ambient pressure experiments, and every minute for pressurized experiments). Average temperature and pressure was recorded from the thermocouple with every withdrawal. (5) Samples were inserted into an ice bath immediately after withdrawal, to quench or stop the reaction. Immediate separations were observed. (6) After the initial separation occurred, samples were washed four times with water to remove excess alcohol and glycerol. Water was washed with a rate of about 5.5% by volume of the methyl ester of oil. Washing the product was a very sensitive process, requiring extreme care to achieve high quality BD. FIG. 4 shows separation of glycerol with BD. (7) Vinegar was then used to wash the product with 1 g for every liter of the product. Hence, it mixed gently. This step was repeated until the ester layer became clearer due to the extraction of excess alcohol and contaminants. FIG. 4 shows separation of acid with BD. (8) The final step was to wait for about 1 hour to allow settling of the mixture and then water 28% by volume of oil was poured into the mixture for the final wash. Phase separation was observed at least within 2 hours of settling, however, the mixture was allowed to settle for about 24 hour to make sure a complete settling occurred. After separation, a spontaneous phase separation was clearly observed. Heavy glycerol phase occupied the lower part of the container containing the alcohol, while the ester phase was provided at a higher part of the container.

An alternative to the manual hand purification method, centrifugation was discovered to have many advantages over manual washing. A centrifuge is a device that uses fast rotation to separate a multi-component complexion liquid. Centrifugal force is applied on the sample. A centrifuge includes a set of controllable parameters, such as speed of rotation, mass of rotating body, and radius of rotation. As the centrifuge spins, the denser materials move towards the outside, leaving the less dense material closer to the center. One of the main benefits of centrifuges is that it provides an efficient separation with short residence times in batch or continuous operations. Also, they can separate fluids with moderately high viscosities and can handle a moderately high solid loading. It has a drawback of being operational and maintenance costly.

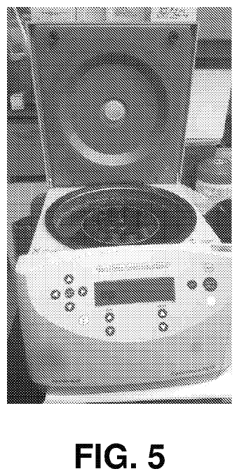

Here, a disk-stacked centrifuge was used, as it can be used for solid/liquid/liquid and liquid/liquid separation applications. FIG. 5 shows some samples that were purified using a centrifuge instrument under a power of about 5000 rpm for about 60 minute.

Experimental Conditions. Batch reactor experiments were designed to achieve the reaction mechanism and associated kinetic rate constant. The experiments took place at temperatures of about 60° C., about 100° C., about 120° C., and about 140° C. and at pressures ranging from ambient pressure to about 5 bar. The reaction chamber was kept at a constant temperature and pressure at all times during the reaction, with temperature control accuracy estimated to be ±1° C. The ratio of methanol:oil was set to be constant at 6:1 molar ratio, it was preferable to maintain a molar ratio of 6:1 as it is the industry accepted standard for the transesterification of vegetable oils (VOs). It was preferable to heat the sodium methoxide and methanol to a temperature as high as 40° C. prior to pouring it into the oil to minimize flash evaporation loss of the methanol.

The vapor pressure of liquids increased as temperature increased, as shown in Table 4. Even though, the increase was not linear (the curve became steeper as temperature increased), as temperature increased, more molecules had enough kinetic energy to overcome the intermolecular force of attraction between molecules in the liquid. Methanol had the higher vapor pressure. Although ethanol molecules also have hydrogen-bonding capability due to the —OH functional group, ethanol has a higher molecular weight than methanol. As a result, methanol had weaker dispersion forces between molecules, and evaporated more easily.

In regards to sampling, each sample was neutralized using sulfuric acid to pause the reaction and preserve the concentrations of the sample layers during the holdup time associated with the shipment and testing of the samples. About every 5 ml of sample was neutralized by about 38 μl of sulfuric acid.

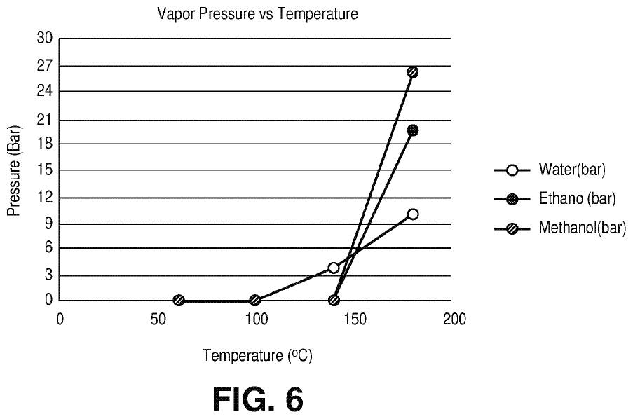

Analytical Methods. Prior to the analyzation, the sample layers were separated and only the BD phase was extracted and thus purified. In order to record the progress of the transesterification reaction, the BD quantification was analyzed by gas chromatography (GC) Agilent 7890A Series. FIG. 6 shows the scheme of a GC system.

GC equipped with a 30 m (length)×0.25 mm (internal diameter)×0.25 μm (film thickness) capillary column coated with DB-Wax (part number 122-7032), and a flame ionization detector (FID). The GC carried the sample through the machine using 1 ml/min helium gas as a carrier for constant flow. A split flow of 100 ml/min was used. The temperature program was set with a 60° C. hold for about 2 minutes, then increased to about 200° C. at a rate of about 10° C. per minute, and then to about 240° C. at a rate of about 5° C. per minute, and then to about 240° C. where it was held for about 7 minutes. The temperature used for injection and detection was about 350° C., and a temperature of about 250° C. was used for FID. Approximately 10 μl of each sample was weighted into individual 1.5 ml vials, and each sample was dissolved in about 1 ml of toluene. Blank methanol and toluene was run through GC first to test the content of them, after which, methyl esters samples were tested.

GC allowed the quantification of BD using several techniques. The equation provided below was one of the techniques used for calculating the production of BD from GC peaks. The fatty acid methyl esters (FAME) was the produced BD.

$$Volume Yield \% = \frac{Volume of Product}{Volume of Oil} \times 100$$

$$Biodiesel Yield \% = FAME \% from GC analysis \times Volume Yield$$

Another technique used for calculating BD production proceeded by adding internal standard and obtaining the calibration curve to calculate the concentrations of monoglyceride (MG), diglyceride (DG), triglyceride (TG), glycerol, and methyl ester at each time interval. Consequently, the quantity converted to methyl esters was determined. The advantage of GC was that it would simultaneously determine GL, MG, DG, and TG. The data from GC was in the form of peaks, wherein each peak related to a specific material by comparing the time of those peaks to each other. The analysis was performed in the isothermal mode. ASTM D6890-07b FAME protocol was used for these conversions.

### Experimental Results

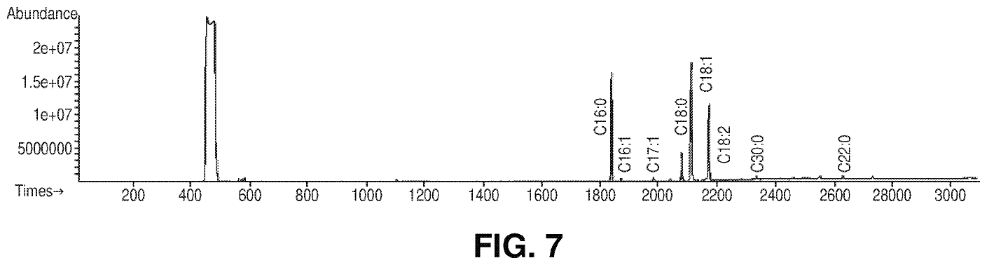

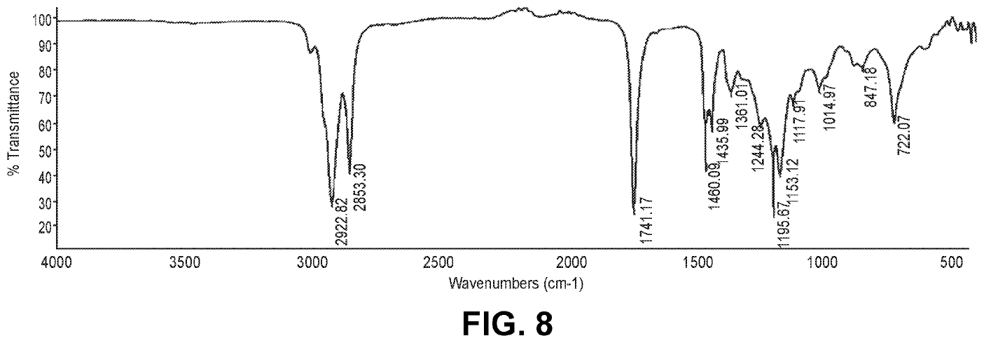

Transesterification process in a batch reactor using sodium hydroxide as a catalyst was used to produce the fatty acid methyl esters that were studied in this project. The results of the study of fatty acid methyl esters (FAME) produced from non-edible newly discovered karaya oil are provided herein. Table 5 shows the composition of FAME for different conversions of karaya oil in a glass reactor and Table 6 shows ester content of karaya biodiesel. FIG. 7 shows the corresponding peaks. FIG. 8 shows FTIR spectrum of karaya methyl ester, according to one or more embodiments of the present disclosure.

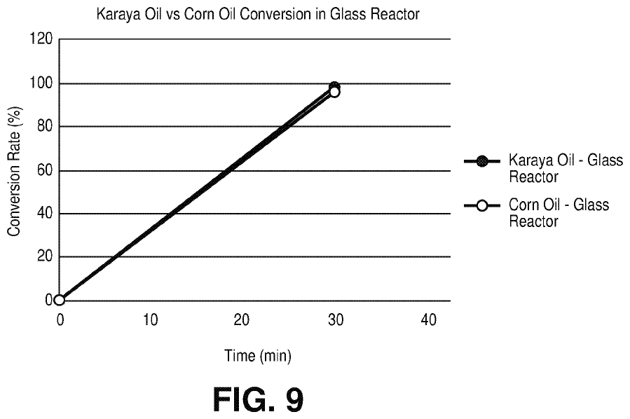

Two different oils were tested under the same conditions to see which one leads to higher conversion of pure oil to methyl esters. FIG. 9 shows a comparison between the conversion rate in compare of karaya oil and corn oil under the same conditions with corn oil converted using the reactor built and explained above.

### Engine Performance Tests

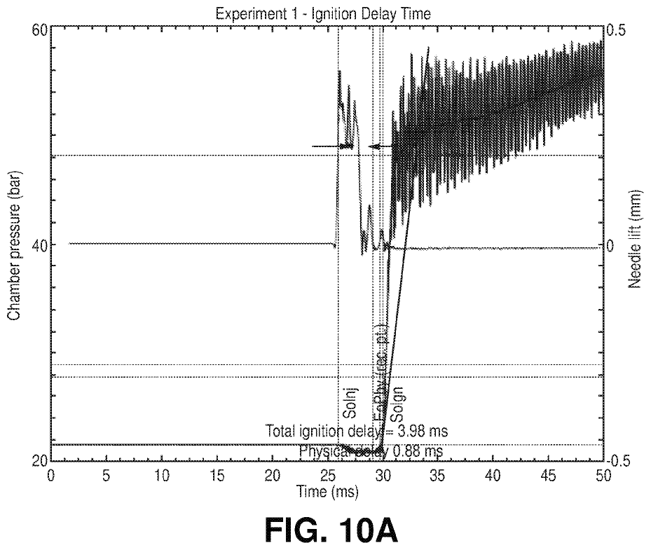

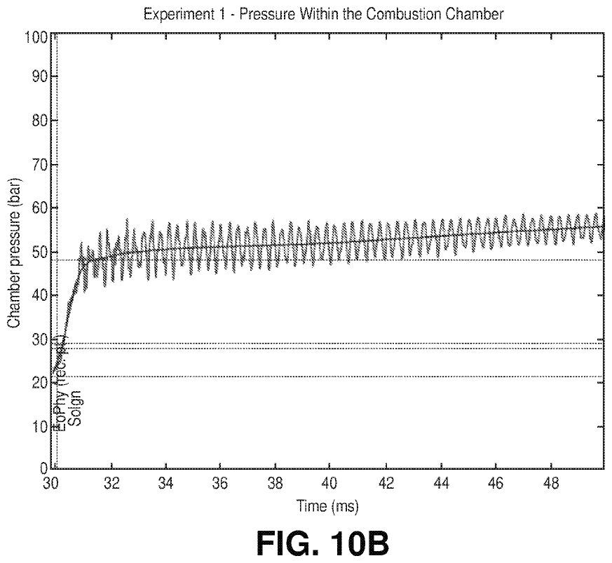

The produced biodiesel of corn oil was evaluated as a fuel in Ignition Quality Test (IQT). IQT is an advanced engine testing technology, it works by calculating the ignition delay time, the time between the start of injection and the start of combustion. The shorter the ignition delay, the higher quality the fuel. Long ignition time fuels explain the low quality of the fuel, which means that the ignition quality is a demanding property of the fuel. Some factors might strongly affect the usability of the fuel, such as temperature and pressure of the environment into which the fuel is injected. Thus, IQT tested the fuel under controlled conditions. IQT was used to determine the following quantification of ignition quality: (1) Cetane number, which uses a standard single cylinder variable compression ratio diesel engine. Cetane number is the most crucial globally accepted ignition quality testing; (2) Cetane index, is a derived value that provide a measure of fuel ignition quality without the need to run cetane number test; and (3) Inside the constant volume combustion chamber, an ignition delay time can be measured and hence cetane number obtained accordingly as what shown in FIGS. 10A-10B.

Eight samples were tested using IQT, plots that showed ignition delays were sketched using Matlab and its corresponding values are provided in Table 7, while Table 8 shows results from IQT software itself. Both results have been taken into consideration for accuracy purposes. n-heptane was studied first because it was a common diesel fuel surrogate, as well as a calibration fuel for the IQT.

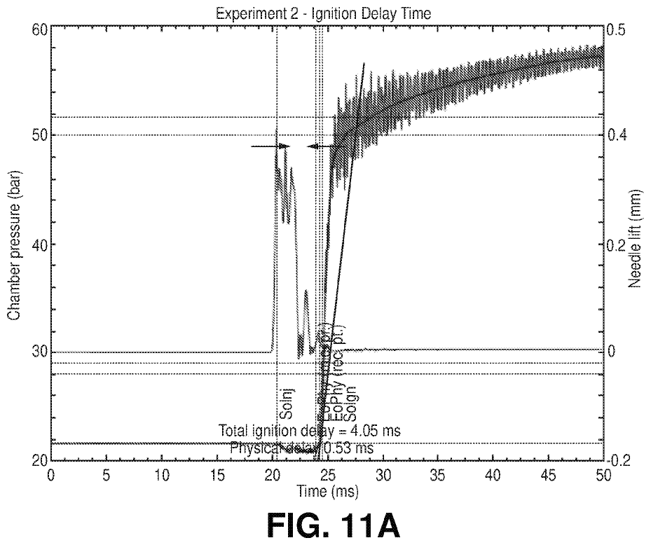

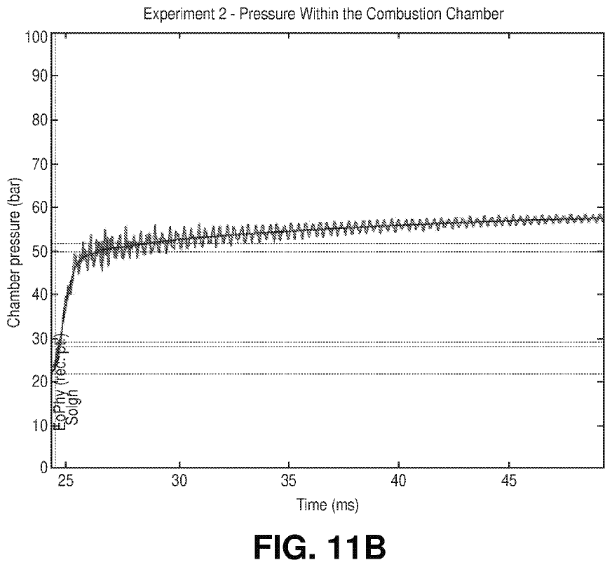

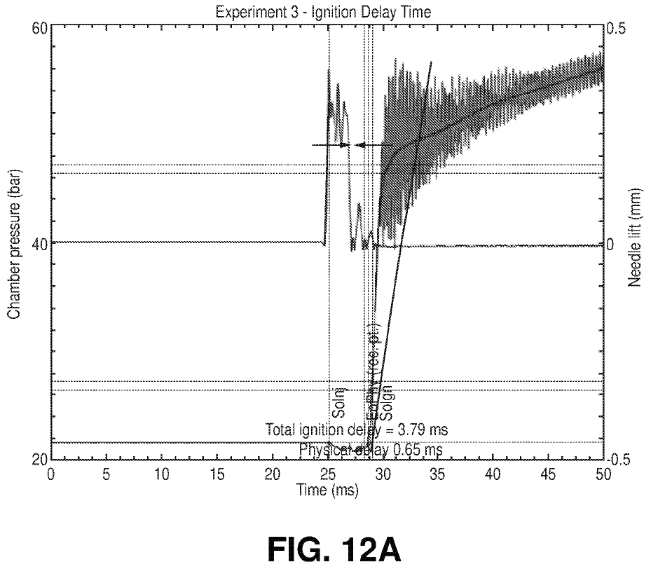

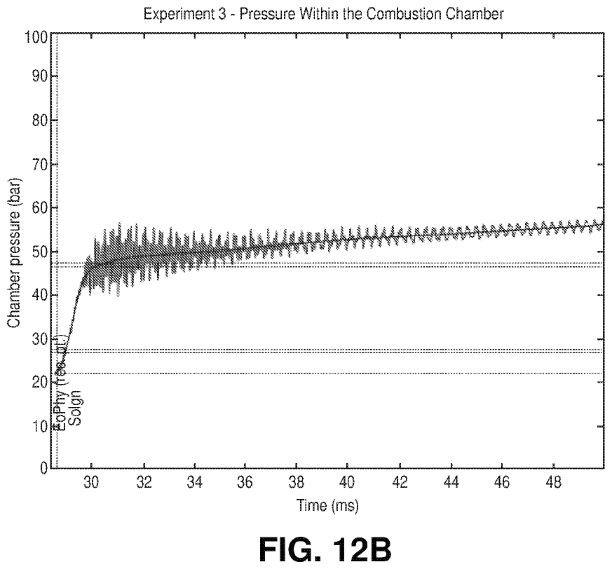

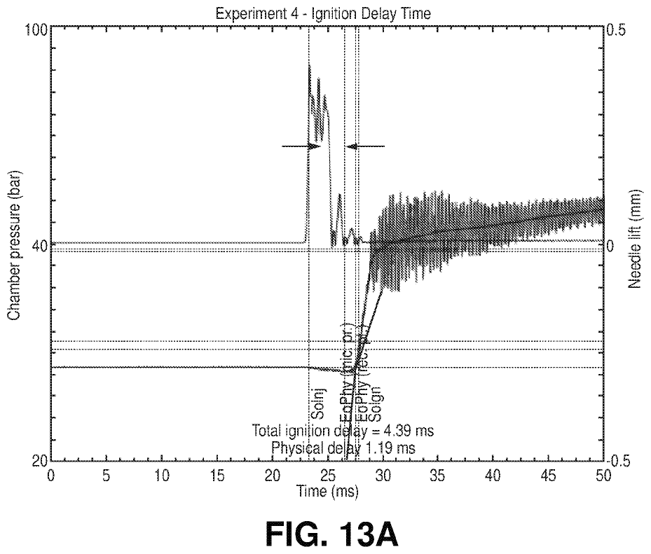

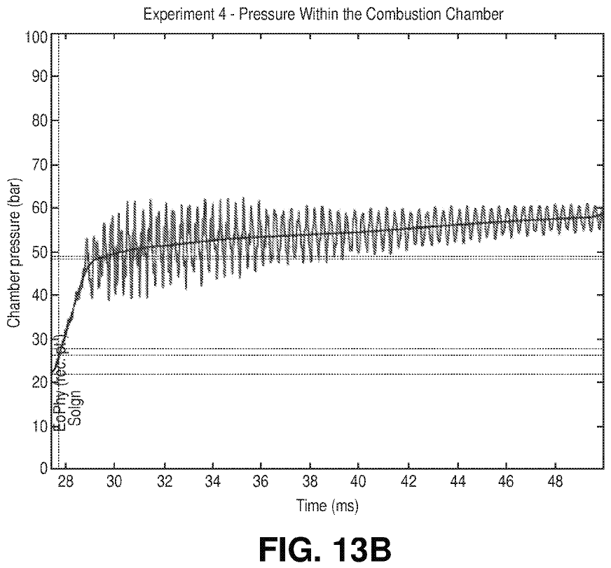

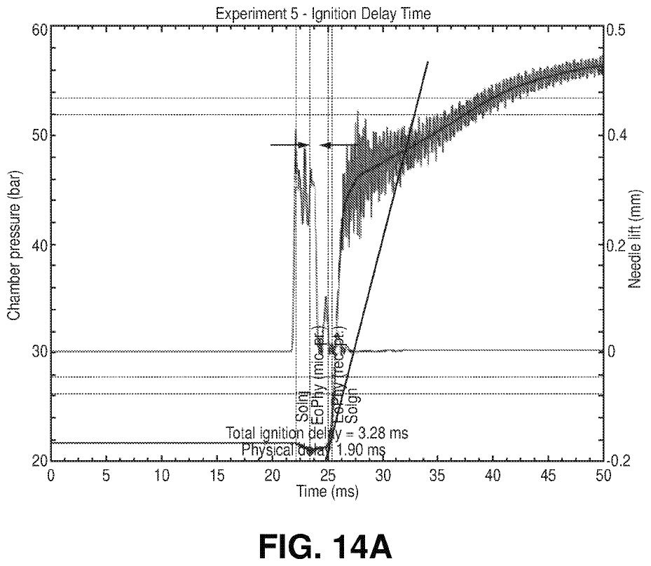

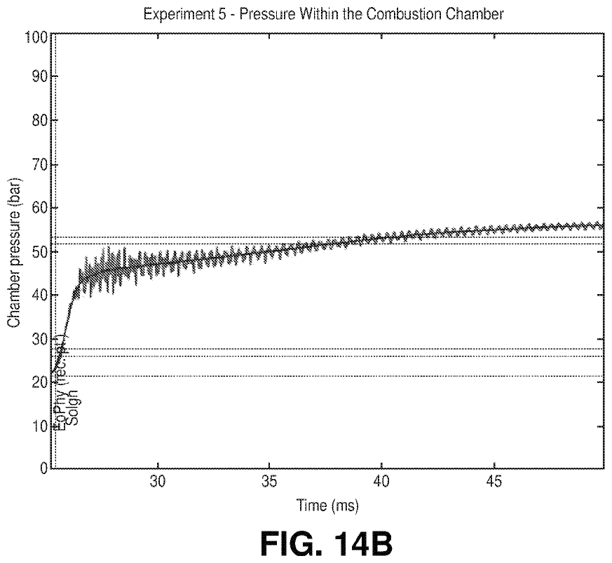

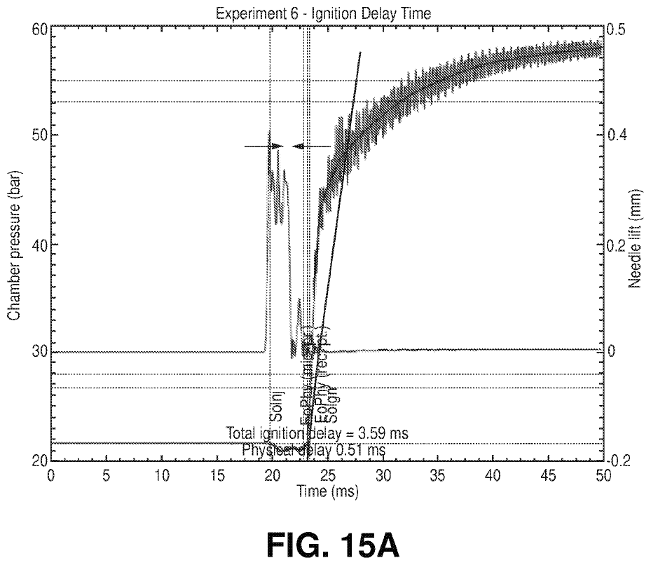

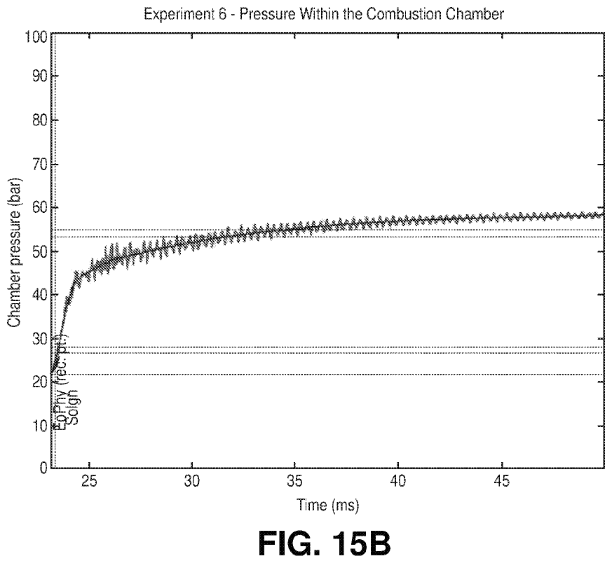

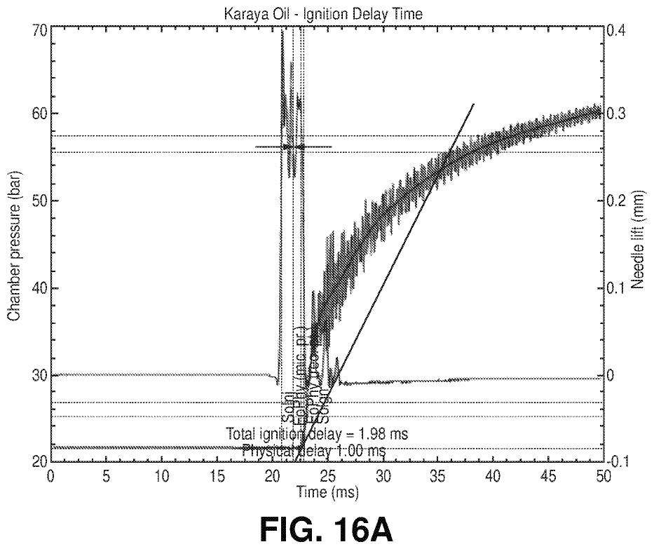

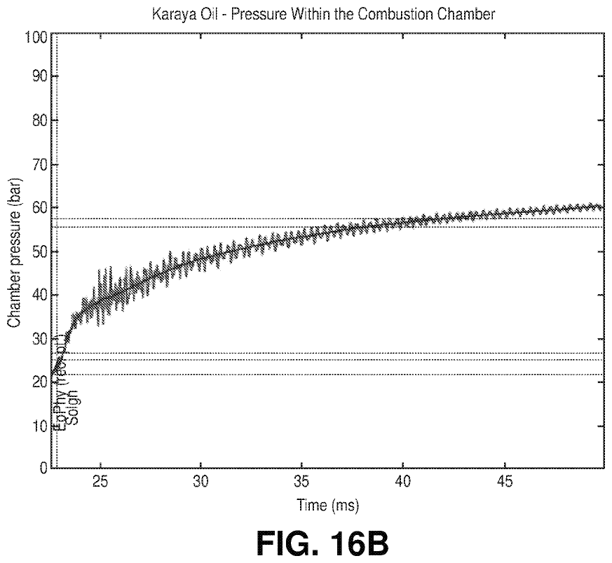

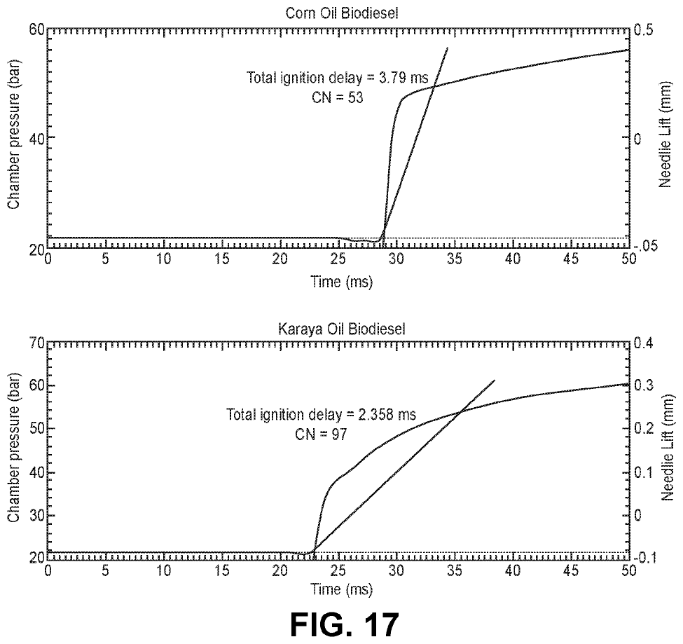

It seemed that results were different when IQT software results were compared with Matlab results. To demystify the confusion in the results, a comparison of the cetane number of heptane from literature was done. In comparison to literature it was clearly seen that the results matched the results from IQT Software, which was thus presumed to be more accurate. FIGS. 10-17 show the ignition delay time and the combustion pressure within the chamber. Difference in IQT between karaya oil and corn oil biodiesels can be seen in FIG. 17.

Viscosity, density, flash point: Physical properties of pure corn oil, diesel, 6 experiments and karaya oil biodiesel. See Table 9.

Calorimeter: A Parr 6400 bomb calorimeter was used to measure the heat of combustion of six biodiesel samples made of corn oil and one biodiesel sample made of karaya oil. The sample produced a value presented in Table 10. All data were subjected to ±0.2 kJ/kg of error. The calculation for the heat of combustion is done by:

$${H}_{c} = \frac{W \times T - {e}_{1} - {e}_{2} - {e}_{3}}{m}$$

where H_{c}— heat of combustion, T—observed temperature rise, W—energy equivalent of the calorimeter being used, e₁—heat produced by burning the nitrogen portion of the air trapped in the bomb to form nitric acid, e₂—the heat produced by the formation of sulfuric acid from the reaction of sulfur oxide, water and oxygen, e₃—heat produced by the heating wire and cotton thread and m—mass of the sample.

Regarding the change in constant rate of the conversion of TG to DG, the increase of temperature led to an increase in the kinetic rate. The same trend was observed in the conversion of DG to MG. Table 11 numerically explains the increase of rate constant as temperature increases. Values of k₂ were slightly lower than k₁ and k₃, which meant that conversion rate of DG was lower than other conversions rates.

### Experimental: Effect of Pressure/Vapor Pressure and Temperature on the Yield Percentage

Headspace GC-MS-FID was used to analyze to obtain the biodiesel methyl esters groups at the produced biodiesel using batch reactor to determine the optimum conditions for that particular reactor. Experiment 1 was carried out under about 100° C. and about ambient pressure, it showed an increase in the conversion rate from about 55.98% to about 89.08% for residence time increased from about 2 minutes to about 24 minutes at constant temperature. Whereas, an increase up to about 92.09% and about 93.08% was observed for the same time interval at about 120° C. and about 140° C., respectively. For experiment that took place at about 5 bar of pressure, at about 100° C., the conversion percent was about 65.13% and increased up to about 92.69% after about 13 minutes. In comparison to ambient pressure, the yield percentage increased in a difference rate of about 3.89% at about half of the time interval. This proved the theory that the increase of pressure in liquids resulted in an increase in kinetic energy of molecules to overcome the intermolecular force of attraction between molecules in the mixture, causing a faster reaction. Residence time of the reaction influenced biodiesel production incredibly, it was assumed that if each experiment performed in longer residence time, it would have produced a higher percentage of methyl esters.

Logically, the longer residence time meant lower flow rate of reactants, which caused the reactants to be applied to heat and pressure for longer times inside the reactor. That resulted in more biodiesel decomposition. Manipulating the factors of temperature and residence time in a measured range was a decent way of lowering the glycerol content in the product, and proportionally more biodiesel. One possible reason that made pressure and residence time good factors for higher yields was because it avoided evaporation of methanol with time by maintaining the methanol in the interface between the two liquids.

Comparing karaya oil with corn oil, it seemed to produce similar yield percentage when under the same conditions. A percentage difference of ˜1.8% was noticed, which was negligible. However, karaya oil seemed to produce the highest FAME number up to C30:0 that has a carbon number of 31. For combustion applications, the higher the carbon number, the higher the cetane number. The higher the cetane number, the faster the ignition delay time and/or the higher fuel quality.

According to GC, there were 11 main characteristic peaks of FAME appearing by the retention time. However, conferring to the peak sequence of FAME, it was clear that the major conversion rate was mainly consisting of palmitic acid (16:0), stearic acid (C18:0), oleic acid (C18:1), linoleic acid (C18:2). Peaks were used to show the amount of change in a sample and peaks area was proportional to the amount of each fatty acid. Thus, the weight percentage of each FA was calculated according to their peaks area for selected samples at fixed time intervals.

### IQT: Engine Performance Test

The cetane number was used to measure the quality of the fuel, as it was related to the ignition delay time inside a combustion chamber. In this work, 6 corn oil based biodiesel samples were tested using IQT, and it was observed that the cetane number ranged between about 48 to 58 Derived Cetane Number (DCN) with an ignition delay time between about 3.5 to 4.2 milli seconds. However, karaya oil showed a huge jump of cetane value and ignition delay. It managed to produce up to about 97 of cetane number that consumed only about 2.4 milli seconds to get ignited. This led to the observation that the variation in temperature and pressure while performing transesterification process might not have had a huge effect when it comes to using the biodiesel in a real engine. That was because the cetane number was almost similar for all corn oil experiments discarding their different experimental conditions. In contrast, karaya oil was performed under basic set up of apparatus and subcritical conditions. Although, it showed a high-quality biodiesel, this may be because of the saturation in the fatty chains in karaya oil over corn oil.

### Biodiesel as Fuel

Some fuel properties like density, kinematic viscosity, flash point, cloud point and pour point were estimated using standard techniques specified by ASTM and these properties were compared with diesel fuel and standard values for biodiesel, for both corn oil methyl ester and karaya oil methyl esters. See Table 12. These values were in the close range and favored the biodiesel produced from non-edible oil (karaya oil) to be used as a fuel. Table 13 shows the physical and chemical properties of karaya methyl ester in comparison to ASTM D 67515. Table 14 shows the physical and chemical properties of karaya biodiesel blends with fossil diesel and ethanol.

In summary, transesterification of corn oil with methanol was carried out under temperature variations of about 100-140° C. in the presence of a catalyst under about ambient pressure and about 5 bar. Six experiments were carried out for 100° C., 120° C. and 140° C. Three experiments were carried out under ambient pressure and the other 3 were carried out under 3 bar of pressure. All samples were purified using a centrifuge and then analyzed in GC and IQT. The evolution of the concentration of each stepwise in the ester phase was closely represented by the kinetic model derived from the proposed consecutive reaction mechanism. According to the kinetic model, TG and MG showed higher reduction rate than DG. Also, temperature was found to have huge effect on the yield percentage, ambient pressure experiments showed a biodiesel conversion up to about 93% in about 20 minutes, while pressurized experiments produced up to about 97% biodiesel in the same time interval. Fuel quality tests showed some similarities and differences between vegetable based biodiesel and petroleum diesel. However, considering the usage for far future, it might make a huge difference in the environment.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

TABLE 1
Physico-chemical Properties of Karaya Crude Oil

| TESTS | Karaya Oil (this study) |
|---|---|
| Kinematic Viscosity @ 40° C., cSt | 37.43 |
| Density @ 15° C., g/ml | 0.9157 |
| Cloud Point, ° C. | 19 |
| Pour point, ° C. | 15 |
| Color, ASTM | (2.8) L 3.0 |
| Water Content, wt % | 3.7 |
| Refractive index @ 20° C. | 1.469 |
| Total Acid Number, mgKOH/g | 37.4 |
| Free Fatty Acids (as Oleic acid), % FFA | 15.88 |
| Iodine Value, gI₂/100 g | 50.91 |
| Saponification Value, mg KOH/g | 180.35 |
| Peroxide value, meq/1000 g | 2 |
| Calorific Value, MJ/Kg | 45.97 |

TABLE 2
Fatty Acids Composition of Karaya Crude Oil

| FATTY ACID | FORMULA | STRUCTURE | AREA % |
|---|---|---|---|
| Palmitic Acid | C₁₆H₃₂O₂ | C16:0 | 56.4 |
| Myristic Acid | C₁₄H₂₈O₂ | C14:0 | 32.8 |
| Heptadecanoic acid | C₁₇H₃₄O₂ | C17:0 | 6.45 |
| Palmitoleic Acid | C₁₆H₃₀O₂ | C16:1 | 1.64 |
| Linolenic Acid | C₁₈H₃₀O₂ | C18:3 | 1.25 |
| Stearic Acid | C₁₈H₃₆O₂ | C18:0 | 1.06 |
| Tri decanoic acid | C₁₃H₂₆O₂ | C13:0 | 0.21 |
| Cis-11-Eicosenoic acid | C₂₀H₃₈O₂ | C20:1 | 0.13 |
| Undecanoic Acid | C₁₁H₂₂O₂ | C11:0 | 0.075 |

TABLE 3
Reactor Details/Experimental Apparatus

| Component | No | Usage | Specification |
|---|---|---|---|
| Tubular | 1 | Holds the chemical reactions | 0.0512 m outer diameter |
| reactor | | | 0.004 m wall thickness |
| | | | 0.0508 m inner thickness |
| | | | 0.91 m height |
| | | | 0.00185 m³ (1.85 litres) |
| | | | Stainless steel |
| Caps | 2 | To allow inflow and outflow | Stainless steel |
| Pump | 3 | Chemical stirring of the reactants | Century ® |
| | | | 1½ hp 3450 RPM 56 J |
| | | | 115/230 V |
| | | | #UST1152 |
| Temperature | 4 | Controls the temperature | Omega ® |
| Controller | | throughout the experiment | 100-240 V, 50/60 Hz, 5 VA |
| Electrical | 5 | Circulating the pipe to heat the | OmegaLaux ®, model |
| heating tapes | | oil and methanol symmetrically | FGH102-100 |
| | | along the tubular reactor | 240 V, 4.33 A and 1040 W |
| Thermocouple | 6 | To measure temperatures of the | — |
| | | tubular reactor | |
| Pressure | 7 | To measure pressure inside the | Keller ® |
| gauge | | tubular reactor | 0-300 bar |
| Inlet port | 8 | It allows the fluid to be poured | Swagelok ® |
| | | into the tubular reactor | |
| Sampling port | 9 | Sample collection | Swagelok ® |
| On/off | 10 | To control the fluid flow | Swagelok ® |
| Switches | | | |

TABLE 4
Vapor Pressure due to Temperature Change

| | 60° C. | 100° C. | 140° C. | 180° C. |
|---|---|---|---|---|
| Water (bar) | 0.199 | 1.019 | 3.590 | 9.974 |
| Ethanol (bar) | 0.468 | 2.259 | 7.569 | 19.65 |
| Methanol (bar) | 0.844 | 3.471 | 10.65 | 26.34 |

TABLE 5
Comparison of FAME for Different Conversions:
Karaya Oil, Glass Reactor

| | Retention | | GC | | |
|---|---|---|---|---|---|
| | Time | | % | Common | |
| Peak # | (min) | FAME | Yield | Name | Formula |
| 1 | 18.439 | C16:0 | 27.00 | Palmitic Acid ME | C₁₇H₃₄O₂ |
| 2 | 18.761 | C16:1 | 0.749 | Palmitoleatic | C₁₇H₃₂O₂ |
| | | | | Acid ME | |
| 3 | 19.873 | C17:1 | 1.112 | 10-heptadecanoic | C₁₈H₃₄O₂ |
| | | | | Acid ME | |
| 4 | 20.838 | C18:0 | 7.677 | Stearic Acid ME | C₁₉H₃₈O₂ |
| 5 | 21.153 | C18:1 | 37.34 | Oleic Acid ME | C₁₉H₃₆O₂ |
| 6 | 21.763 | C18:2 | 22.27 | Linoleic Acid ME | C₁₉H₃₄O₂ |
| 7 | 23.408 | C30:0 | 0.924 | Melissatic Acid ME | C₃₁H₆₂O₂ |
| 8 | 26.364 | C22:0 | 1.115 | Behenic Acid ME | C₂₃H₄₆O₂ |

| | |
|---|---|
| Total | 98.19 |

Experimental Conditions: T = 100° C., ambient pressure, Oil = 800 ml, Methanol = 300 ml, NaOH = 7 g. sampling started after 15 minutes of adding methanol.

TABLE 6
Ester Content of Karaya Biodiesel

| | | GC | | |
|---|---|---|---|---|
| | | % | Common | |
| No. | FAME | Yield | Name | Formula |
| 1 | C16:0 | 19.66 | Palmitic Acid ME | C₁₇H₃₄O₂ |
| 2 | C16:1 | 2.37 | Palmitoleatic | C₁₇H₃₂O₂ |
| | | | Acid ME | |
| 3 | C17:1 | 2.03 | 10-heptadecanoic | C₁₈H₃₄O₂ |
| | | | Acid ME | |
| 4 | C18:0 | 8.18 | Stearic Acid ME | C₁₉H₃₈O₂ |
| 5 | C18:1 | 7.10 | Methyl2-OCTYLcyclopropene- | C₁₉H₃₄O₂ |
| | | | 1-heptanoate | |
| 6 | C18:2 | 17.58 | Linoleic Acid ME | C₁₉H₃₄O₂ |
| 7 | C18:1 | 18.97 | Oleic Acid ME | C₁₉H₃₆O₂ |
| 8 | | 20.94 | OTHER ESTERS | |

| | |
|---|---|
| Total | 96.83 |

TABLE 7
IQT Results Generated from Matlab

| | Derived | Standard | Ignition | Standard |
|---|---|---|---|---|
| | Cetane | Deviation | Delay | Deviation |
| | Number | of | Time | Ignition |
| Fuel | (DCN) | DCN | (ms) | Delay |
| Heptane | 57.87 | 0.73 | 3.494 | 0.047 |
| Exp 1 | 52.53 | 0.91 | 3.883 | 0.074 |
| Exp 2 | 50.73 | 0.89 | 4.034 | 0.077 |
| Exp 3 | 54.43 | 1.67 | 3.738 | 0.119 |
| Exp 4 | 48.42 | 1.47 | 4.249 | 0.136 |
| Exp 5 | 57.11 | 2.17 | 3.549 | 0.143 |
| Exp 6 | 55.78 | 1.19 | 3.638 | 0.085 |
| Karaya Oil | 135.79 | 7.62 | 2.017 | 0.046 |

TABLE 8
IQT Results Generated from IQT Software

| | Derived | Standard | Ignition | Standard | |
|---|---|---|---|---|---|
| | Cetane | Deviation | Delay | Deviation | Test |
| | Number | of | Time | Ignition | Temperature |
| Fuel | (DCN) | DCN | (ms) | Delay | (° C.) |
| Heptane | 53.87 | 0.65 | 3.777 | 0.049 | 566.4 |
| Exp 1 | 50.05 | 1 | 4.093 | 0.089 | 569.4 |
| Exp 2 | 48.51 | 1.02 | 4.236 | 0.097 | 570.1 |
| Exp 3 | 51.82 | 1.29 | 3.94 | 0.105 | 570.2 |
| Exp 4 | 46.9 | 2.1 | 4.397 | 0.207 | 570.1 |
| Exp 5 | 54.28 | 1.64 | 3.746 | 0.121 | 570.3 |
| Exp 6 | 53.33 | 1.34 | 3.818 | 0.105 | 569.9 |
| Karaya Oil | 97.27 | 3.78 | 2.358 | 0.051 | 569.7 |

TABLE 9
Viscosity of Individual Biodiesel Sample

| | Dynamic | Kinematic | | |
|---|---|---|---|---|
| | Viscosity | Viscosity | Density | Flash Point |
| Fuel | (mPas) | (m²/s) | (g/cm³) | (° C.) |
| Diesel | 3.0 | 3.509 | 0.8550 | 76.00 |
| Pure Corn Oil | 59 | 64.764 | 0.9110 | 335.0 |
| Exp 1 | 9.1 | 10.537 | 0.8636 | 172.2 |
| Exp 2 | 8.9 | 10.339 | 0.8608 | 172.0 |
| Exp 3 | 8.7 | 10.082 | 0.8629 | 170.7 |
| Exp 4 | 8.9 | 10.287 | 0.8652 | 169.2 |
| Exp 5 | 9.4 | 10.899 | 0.8625 | 164.4 |
| Exp 6 | 7.8 | 9.038 | 0.8630 | 164.2 |
| Karaya Oil ME | 10 | 11.403 | 0.8770 | 158.2 |

TABLE 10
Heat of Combustion

| | |
|---|---|
| Weight | Heat of Combustion |

| Sample Type | (g) | (Btu/lb) | (MJ/kg) |
|---|---|---|---|
| Diesel | 0.6440 | 19.64 | 45.69 |
| Pure Corn Oil | 0.5923 | 16.80 | 39.09 |
| Exp 1 | 0.6948 | 16.07 | 37.38 |
| Exp 2 | 0.7204 | 15.90 | 36.99 |
| Exp 3 | 0.5920 | 16.21 | 37.72 |
| Exp 4 | 0.6466 | 16.07 | 37.38 |
| Exp 5 | 0.5786 | 16.51 | 38.41 |
| Exp 6 | 0.6425 | 16.66 | 38.76 |
| Karaya Oil ME | 0.6264 | 16.76 | 38.99 |

TABLE 11
Rate Constant with Relation of Temperature

| Temperature | k₁ | k₂ | k₃ |
|---|---|---|---|
| (° C.) | (kg/mol/s) | (kg/mol/s) | (kg/mol/s) |
| 100 | 8.2115 × 10⁻¹¹ | 7.4975 × 10⁻¹¹ | 7.8545 × 10⁻¹¹ |
| 120 | 4.5252 × 10⁻⁹ | 4.1317 × 10⁻⁹ | 4.3285 × 10⁻⁹ |
| 140 | 7.9317 × 10⁻⁸ | 7.2420 × 10⁻⁸ | 7.5869 × 10⁻⁸ |

TABLE 12
Fuel Properties

| | ASTM | | | Biodiesel (ME) | |
|---|---|---|---|---|---|
| | Standard | | | Corn | Karaya |
| Properties | (ref 1) | Diesel | Biodiesel | Oil | Oil |
| Derived | ASTM D6890 | 40-44 | 46-52 | 47-53 | 97.27 |
| Cetane | | | | | |
| Number (DCN) | | | | | |
| Density | ASTM D941 | 0.843 | 0.875 | 0.864 | 0.877 |
| (g/m³) | | | | | |
| Viscosity | ASTM D445 | 2.53 | 3.46 | 8.8 | 10 |
| (mPa) | | | | | |
| Kinematic | | 3.00 | 3.95 | 7.60 | 8.77 |
| Viscosity | | | | | |
| (10⁻⁶ m²/s) | | | | | |
| Flash Point | ASTM D93 | 76 | 100 | 170.7 | 158.2 |
| (° C.) | | | | | |
| Heat of | ASTM D2015 | 45.36 | 41.17 | 37.77 | 38.84 |
| Combustion | | | | | |
| (MJ/kg) | | | | | |

TABLE 13
Physical and Chemical Properties of Karaya
Methyl Ester in Comparison to ASTM D 67515

| TESTS | ASTM D 6751 | Karaya Methyl Ester^{a} |
|---|---|---|
| Kinematic Viscosity @ 40° C., cSt | 1.9-6.0 | 5.272 |
| Cloud Point, ° C. | REPORT | 6 |
| Pour point, ° C. | — | 6 |
| CFPP, ° C. | — | 3 |
| Color, ASTM | — | L 3.0 |
| Density @ 15° C., g/ml | — | 0.8873 |
| Free Fatty Acids (as Oleic acid), % FFA | — | 0.14 |
| Total Acid Number, mgKOH/g | Max. 0.50 | 0.31 |
| Flash Point, ° C. | Min. 93 | 158.0 |
| Water Content, wt % | — | 0.1 |
| Copper Strip Corrosion (3 Hours @ 100° C.), | Max. 3 | 1B |
| Rating | | |
| Sulfated Ash, Wt % | Max. 0.02 | 0.007 |
| Sulfur Content, % mass | Max. 0.05 | 0.012 |
| Phosphorus content, mg/kg | Max. 10 | 1 |
| Calcium, mg/kg | Max. 5 | 2 |
| Magnesium, mg/kg | Max. 5 | <1 |
| Sodium, mg/kg | Max. 5 | 15 |
| Potassium, mg/kg | Max. 5 | 3 |

TABLE 14
Physical and Chemical properties of Karaya Biodiesel Blends with Fossil Diesel and Ethanol

| TESTS | ASTM D7467 | B20 | D60B20E20 | D80B10E10 | D80B15E5 |
|---|---|---|---|---|---|
| Kinematic Viscosity @ 40° C., | 1.9-4.1 | 2.908 | 2.660 | 2.924 | 3.175 |
| cSt | | | | | |
| Cloud Point, ° C. | — | −3 | +5 | +3 | +4 |
| Pour point, ° C. | — | −6 | +3 | 0 | +3 |
| CFPP, ° C. | — | −12 | −2 | 0 | −1 |
| Color, ASTM | — | L 2.5 (2.3) | L 2.0 (1.6) | L 1.5 (1.4) | L 2.0 (1.7) |
| Density @ 15° C., g/ml | — | 0.8416 | 0.8352 | 0.8347 | 0.8392 |
| Total Acid Number, | Max. 0.3 | 0.19 | 0.17 | 0.20 | 0.20 |
| mgKOH/g | | | | | |
| Flash Point, ° C. | Min. 52 | 70.0 | 14.0 | 16.0 | 18.0 |
| Water Content, wt % | 0.05 | <0.05 | 0.259 | 0.056 | 0.049 |
| Copper Strip Corrosion (3 | No. 3 | 1A | 1A | 1A | 1A |
| Hours @ 100° C.), Rating | | | | | |
| Distillation Temperature, 90% | Max. 343 | 343 | — | — | — |
| vol recovered | | | | | |
| Sulfur Content, % mass | Max. 0.05 | 0.009 | 0.0046 | 0.0059 | 0.0062 |

1. A method of producing a fuel additive from karaya oil, comprising:
reacting a karaya oil extract with an alcohol in the presence of a catalyst to produce fatty acid esters in a crude product mixture; and
separating the fatty acid esters from the crude product mixture to obtain a fuel additive.

2. The method of claim 1, wherein the reacting proceeds by contacting the karaya oil extract with the alcohol and catalyst to form a reaction solution.

3. The method of claim 1, wherein the reacting proceeds by heating the reaction solution to a first temperature.

4. The method of claim 1, wherein the first temperature ranges from about 60° C. to about 140° C.

5. The method of claim 1, wherein the karaya oil extract includes triglycerides, free fatty acids, water, or a combination thereof.

6. The method of claim 1, wherein the alcohol is methanol, ethanol, propanol, butanol, amyl alcohol, isopropanol, or butanol.

7. The method of claim 1, wherein a molar ratio of the alcohol to karaya oil extract is at least about 3:1, about 6:1, or about 12:1.

8. The method of claim 1, wherein the catalyst is sodium hydroxide, potassium hydroxide, sodium carbonate, potassium carbonate, sodium methoxide, sodium ethoxide, sodium propoxide, or sodium butoxide

9. The method of claim 1, wherein the fatty acid esters are mono-alkyl esters of long chain fatty acids.

10. The method of claim 1, wherein the fatty acid esters include one or more of palmitic acid methyl ester, palmitoleatic acid methyl ester, 10-heptadecanoic acid methyl ester, stearic acid methyl ester, oleic acid methyl ester, linoleic methyl ester, melissatic acid methyl ester, and behenic acid methyl ester.

11. The method of claim 1, wherein the separating proceeds by washing or centrifuging the crude product mixture.

12. The method of claim 1, further comprising forming a mixture in which the catalyst is dissolved in the alcohol.

13. The method of claim 1, further comprising heating the karaya oil extract, a mixture of the alcohol and catalyst, or both to a second temperature prior to the reacting.

14. A fuel additive composition comprising a mixture of fatty acid methyl esters derived from karaya oil.

15. The composition of claim 14, wherein the mixture consists of or consists essentially of the fatty acid methyl esters derived from karaya oil.

16. The composition of claim 14, wherein a cetane number of the composition is at least about 90 CN.

17. The composition of claim 14, wherein an ignition delay time of the composition is about 2.4 mS.

18. A fuel composition comprising about 2% to about 100% of a fuel additive composition and about 0% to about 98% of diesel fuel.

19. The composition of claim 18, wherein the fuel additive composition includes fatty acid methyl esters derived from karaya oil.

20. The composition of claim 18, wherein the fatty acid methyl esters include one or more of palmitic acid methyl ester, palmitoleatic acid methyl ester, 10-heptadecanoic acid methyl ester, stearic acid methyl ester, oleic acid methyl ester, linoleic methyl ester, melissatic acid methyl ester, and behenic acid methyl ester.
